(19) United States
(12) Patent Application Publication
(10) Pub. No.: US 2003/0014284 A1
(43) Pub. Date: Jan. 16, 2003

(54) Computer program and method for facilitating medical treatment and related billing

(76) Inventor: Jana Jones, Leavenworth, KS (US)

Correspondence Address: HOVEY WILLIAMS LLP, 2405 Grand Boulevard, Suite 400, Kansas City, MO, 64108, US

(21) Appl. No.: 10/155,638

(22) Filed: May 22, 2002

Related U.S. Application Data
(60) Provisional application No. 60/292,633, filed on May 22, 2001.

(51) Int. Cl. G06F 17/60

(52) U.S. Cl. 705/3

(57) ABSTRACT

A computer program and method for facilitating medical treatment and related billing is disclosed. The computer program is storable, accessible, and executable on a system (10). The computer program includes a first subprogram (16) operable to provide a database including medical information for substantially all of the specific groupings of systems of the human body, a second subprogram (18) operable to provide an input mechanism operable to accept patient data, a third subprogram (20) operable to correlate the patient data with medical information from one or more of the specific groupings of systems of the human body, and a fourth subprogram (22) operable to generate a report matching the patient data with the correlated medical information. The computer program provides an input form (24), that once filled, converts to an output form. An alternative input form (42) is also disclosed. The inventive program provides a comprehensive and accurate medical history and physical examination of a patient that is efficient and cost effective to complete for the health care provider and formatted in compliance with substantially all third party billing requirements.

### RELATED APPLICATION

This application claims the benefit of U.S. Provisional Application No. 60/292,633 filed May 22, 2001 and entitled COMPUTER PROGRAM AND METHOD FOR FACILITATING MEDICAL TREATMENT AND RELATED BILLING that is hereby incorporated herein by reference.

### COMPUTER PROGRAM LISTING

A computer program listing appendix containing the source code of a computer program that may be used with the present invention is incorporated herein by reference and appended to the incorporated U.S. Provisional Application No. 60/292,633 referenced above as one original compact disk, and an identical copy thereof, containing a total of two files as follows:

| Filename: | Size (Bytes): | Date of Creation: |
|---|---|---|
| HISTPHYS.TXT | 2,015,514 | Apr. 27, 2001 |
| PROGNOTE.TXT | 1,974,436 | Apr. 27, 2001 |

### BACKGROUND OF THE INVENTION

1. Field of the Invention

The present invention relates generally to computer programs for and methods of receiving and formatting medical information. More particularly, the present invention relates to a computer program and method for facilitating medical treatment and related billing that enables a health care provider to take a comprehensive and accurate physical examination and medical history of a patient that is compliant with substantially all third party billing requirements.

2. Discussion of Prior Art

Health care providers typically take a medical history and conduct a physical examination of every new patient. In addition, health care providers typically take some form of a history and physical examination of repeat patients, although it may be more focused (e.g., to determine progress from the previous examination or in response to a new complaint, etc.). Based on the history and physical, the health care provider makes medical findings, reaches a diagnosis, and/or records progress notes, and recommends treatment to the patient. The medical information, including the history, physical, findings, diagnosis, treatment and/or progress notes are then recorded. The recorded medical information is then typically converted into one of several different forms for processing by a third party. For example, the major insurance carriers (e.g., Medicaid, Medicare, etc.) each have various, diverse requirements for information needed, the format of the information provided, and the testing conducted on the patient that a health care provider must comply with before the health care provider is eligible to be reimbursed for the services rendered to the patient.

Prior art methods for collecting the above described medical information include standardized forms and/or questionnaires manually filled out by the patient, the health care provider, or a staff member of the health care provider. Prior art collection methods also include health care providers (and/or their staff) manually recording in print or dictating onto magnetic tape their observations and/or notes from the history and physical examinations. Prior art methods for analyzing the medical information include the health care provider, after collecting the information, drawing on their experience and/or training and/or consulting other health care providers and/or treatises, to determine what medical findings are necessary, then reaching a diagnosis based on those findings, and recommending treatment based on that diagnosis. Prior art methods for processing the medical information include transferring information from the health care provider's notes onto standardized forms for submission to the third party or transcribing the health care provider's dictation tapes and/or converting them into a report for submission to the third party.

These prior art methods are problematic and have several limitations. For example, health care providers that rely on memory and experience may omit relevant medical findings and/or necessary testing during the physical examination resulting in an incomplete history and physical. Some of these prior art methods are also very time consuming and costly, for example, transcribing dictation.

### SUMMARY OF THE INVENTION

The present invention provides an improved method for facilitating medical treatment and related billing that does not suffer from the problems and limitations of prior art methods set forth above. The inventive method provides a comprehensive and accurate history and physical that is efficient and cost effective to complete and formatted in compliance with substantially all third party requirements.

A first aspect of the present invention concerns a method for facilitating medical treatment and related billing relating to one or more specific groupings of systems of the human body wherein the one or more groupings is selected from the group comprising substantially all of the specific groupings of systems of the human body. The method of the present invention broadly includes the steps of providing a database including medical information for substantially all of the specific groupings of systems of the human body, providing an input mechanism operable to accept patient data, correlating the patient data with medical information from one or more of the specific groupings of systems of the human body, and generating a report matching the patient data with the correlated medical information.

A second aspect of the present invention concerns a computer program for facilitating medical treatment and related billing relating to one or more specific groupings of systems of the human body wherein the one or more groupings is selected from the group comprising substantially all of the specific groupings of systems of the human body. The computer program is stored on a computer-readable medium and executable by a computing device. The computer program of the present invention broadly includes a first code segment operable to provide a database including medical information for substantially all of the specific groupings of systems of the human body, a second code segment operable to provide an input mechanism operable to accept patient data, a third code segment operable to correlate the patient data with medical information from one or more of the specific groupings of systems of the human body, and a fourth code segment operable to generate a report matching the patient data with the correlated medical information.

A third aspect of the present invention concerns a system for facilitating medical treatment of a patient and related billing relating to specific groupings of systems of the human body. The system of the present invention broadly includes a handheld computing device and a computer program. The computing device includes a memory, a display, an input mechanism, and an output mechanism. The computer program is stored in the memory and executable to process medical information relating to substantially all of the specific groupings of systems of the human body. The computer program includes a first code segment providing a database stored in the memory and including medical information for substantially all of the specific groupings of systems of the human body when the first code segment is executed. The computer program includes a second code segment controlling the input mechanism to accept patient data when the second code segment is executed. The computer program includes a third code segment correlating the patient data with medical information from one or more of the specific groupings of systems of the human body when the third code segment is executed. The computer program includes a fourth code segment generating a report matching the patient data with the correlated medical information when the fourth code segment is executed.

Other aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a front elevational view of a system for facilitating medical treatment constructed in accordance with a preferred embodiment of the present invention;

FIG. 2 is a flow diagram illustrating the steps involved in facilitating medical treatment and related billing in accordance with the present invention;

FIG. 3 is a representative input form generated by a computer program of a preferred embodiment of the present invention and having fillable and selectable data fields relating to medical information regarding past medical history of a patient that is convertible into an output form;

FIGS. 4, 5, and 6 are representative input forms generated by the computer program and having fillable and selectable data fields relating to medical information regarding review of systems of a patient that are convertible into output forms;

FIGS. 7, 8, 9, and 10 are representative input forms generated by the computer program and having fillable and selectable data fields relating to medical information regarding physical examination of a patient that are convertible into output forms;

FIG. 11 is a representative input form generated by the computer program and having fillable and selectable data fields relating to medical findings of a health care provider that is convertible into an output form;

FIG. 12 is an exemplary screen capture generated by the computer program and showing a drop down menu relating to symptoms that correspond to a specific grouping;

FIG. 13 is a representative alternative input form generated by a computer program constructed in accordance with an alternative preferred embodiment of the present invention and having fillable and selectable data fields relating to medical information regarding past medical history of a patient that is convertible into an output form;

FIGS. 14 and 15 are representative alternative input forms generated by the alternative computer program and having fillable and selectable data fields relating to medical information regarding review of systems of a patient that are convertible into output forms; and

FIGS. 16, 17, 18, 19, and 20 are representative alternative input forms generated by the alternative computer program and having fillable and selectable data fields relating to medical information regarding physical examination of a patient that are convertible into output forms.

### DETAILED DESCRIPTION OF THE PREFERRED EMBODIMENTS

The present invention is a computer program and method for facilitating medical treatment and related billing that provide a comprehensive and accurate medical history and physical examination of a patient that is efficient and cost effective to complete for the health care provider and formatted in compliance with substantially all third party billing requirements. In particular, the present invention provides a database having substantially all of the specific groupings of the systems of the human body; therefore, the health care provider is guided through a comprehensive physical examination. In addition, each specific grouping includes etiological related headings that remind the health care provider of necessary findings. The present invention further allows the health care provider to record events as they occur during the physical examination in a final format, thereby eliminating costly and time consuming steps associated with prior art methods. The present invention is equally applicable to an initial history and physical of a new patient as well as a history and physical targeting progress notes for an existing patient. In this manner, the present invention provides the health care provider with a comprehensive and accurate medical history and physical examination of a patient that is efficient and cost effective to complete and formatted in a final form compliant with substantially all third party billing requirements.

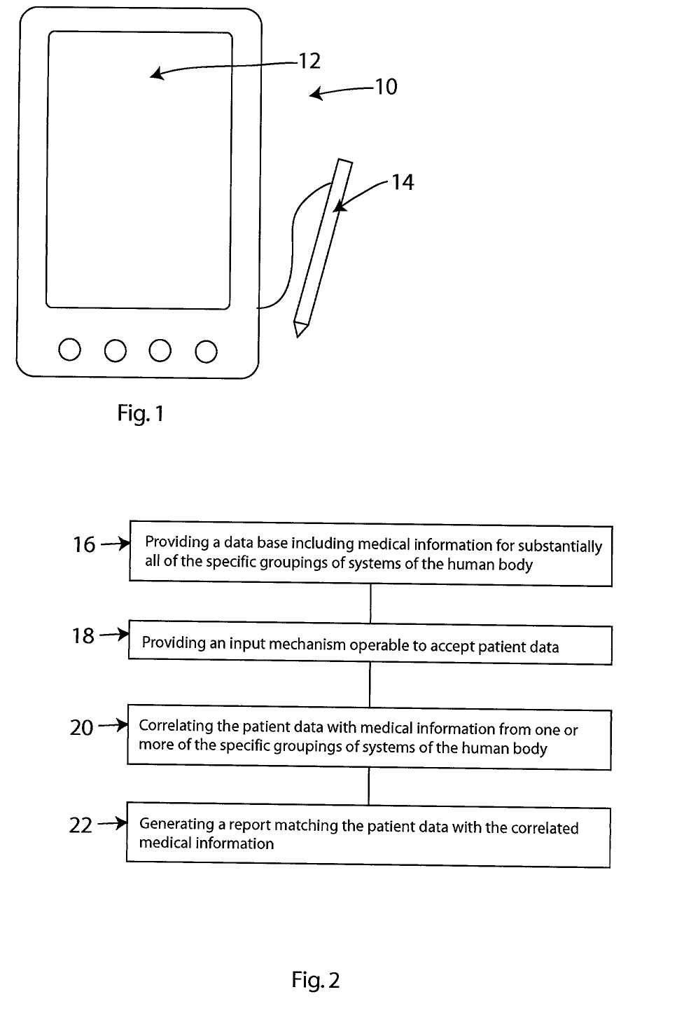

Referring to FIG. 1, a system 10 is shown for storing, accessing, and executing the computer program of the present invention. The illustrated system 10 is a handheld, portable computing device, such as for example a personal digital assistant (PDA), commonly available from a variety of well-known suppliers. The system 10 includes a resident copy of the medical treatment and billing program. Such portability advantageously allows the system 10 to be carried into an examination room where examination of a patient occurs to allow both simultaneous creation of the medical history during the physical examination as well as an instant reference prompting the health care provider to make the necessary etiological findings. Although the system 10 is preferably a handheld computing device, the system could be any suitable computing device having sufficient resources and ability to perform the functions described herein. For example, the system could comprise a conventional laptop or notebook computer. Such system hardware is conventional and widely available from a variety of manufacturers and retailers, including, for example, Micron Electronics Incorporated, Dell Computer Corporation, and Compaq Computer Corporation.

Regardless of its form, however, the preferred system 10 broadly includes a memory, a data communication connection, a processor, a display 12, an input device 14, and an output device. The memory is operable to store the subprograms and databases of the computer program, and may be embodied in random access memory (RAM), a hard drive, a disk, or any other similar conventional computer memory.

The data communication connection, in addition to being operable to communicate with the conventional output device such as a printer, is operable to allow the system 10 to transfer one or more of the subprograms and databases or copies thereof to or from a remote second computing device (not shown). The data communication connection may be, for example, any wired or wireless network-type connection, including a local area network (LAN) connection, a wide area network (WAN) connection, or a modem internet connection. The remote second computing device may be, for example, a conventional server computer operated by a third party insurer.

The processor is operable to execute the computer program. The display 12 is operable to communicate information generated by the processor during execution of the computer program. The input device 14 is operable to allow a user to interact with the computer program. In the illustrated system 10, the input device 14 is a pointing device operable to interface with the display 12, such as a stylus. It will be appreciated that the nature of the processor, display 12, and input device 14 will depend at least to some extent on the nature of the system 10, though all are preferably commonly available from a variety of well-known suppliers.

Referring to FIG. 2, the medical treatment and billing program is preferably a cross-platform fully-integrated computer program comprising a number of subprograms each comprised of a combination of code segments executable by the above-described system 10. The computer program broadly includes a first subprogram 16 operable to provide a database of medical information, a second subprogram 18 operable to receive patient data, a third subprogram 20 operable to correlate the patient data with the medical information, and a fourth subprogram 22 operable to generate a formatted report matching the patient data with the correlated medical information. The computer program is operable to be stored on the memory or accessed via the data communication connection and executed by the processor. Though implementable in any conventional computer programming language, the program is preferably implemented in Microsoft Word (e.g., using SCRIPT WIZARD, etc.). A computer listing appendix of source code operable to implement the present invention was appended to the incorporated U.S. Provisional Application No. 60/292,633 referenced above and is incorporated herein by reference. However, the medical treatment and billing program could utilize any suitable programming language and can be executed on any suitable text editor software in any suitable operating environment. Exemplary applications include Visual Basic for Applications (programming); Word, WordPerfect, OmniForm, and PocketWord (text editor); and Windows and Windows NT (operating).

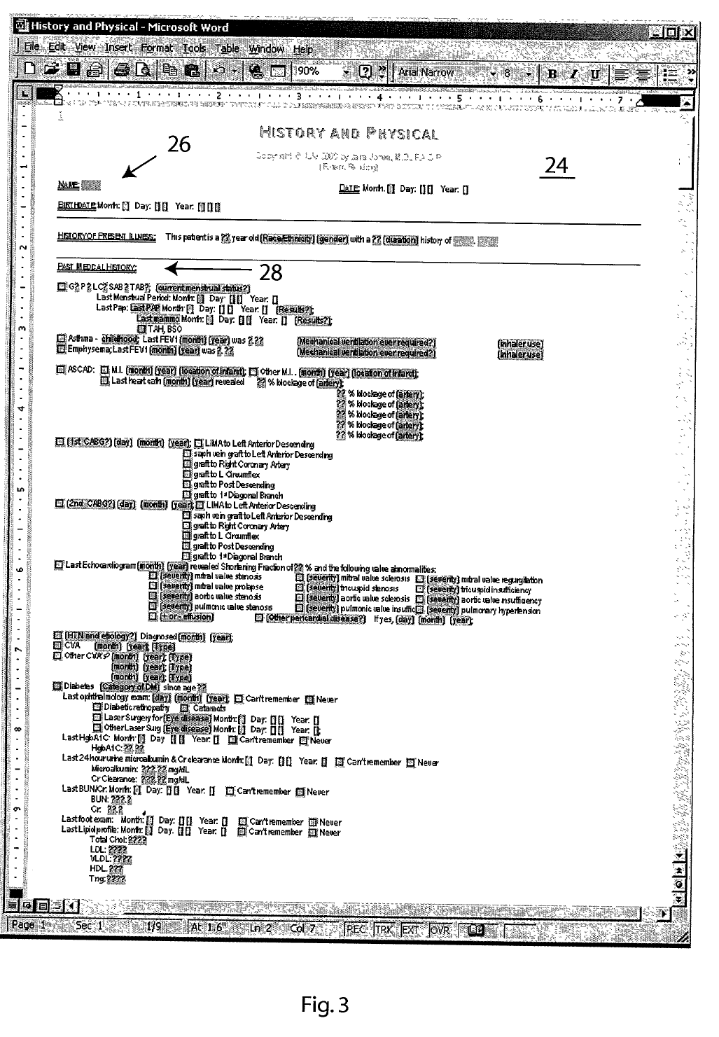

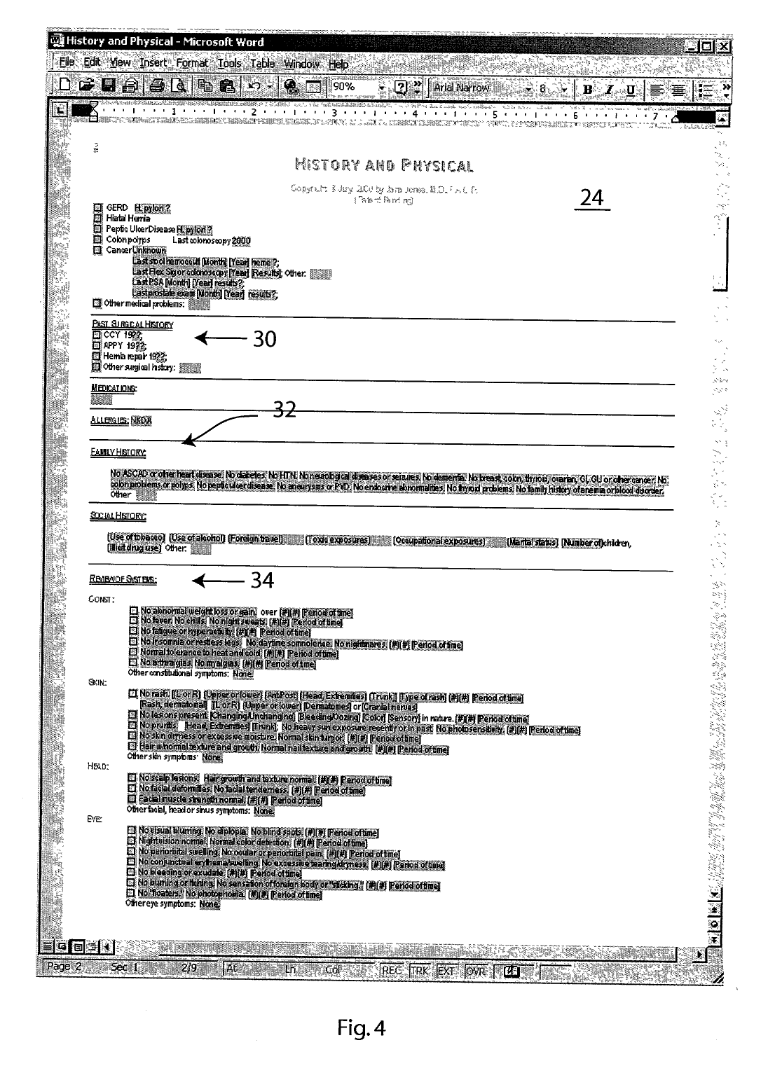

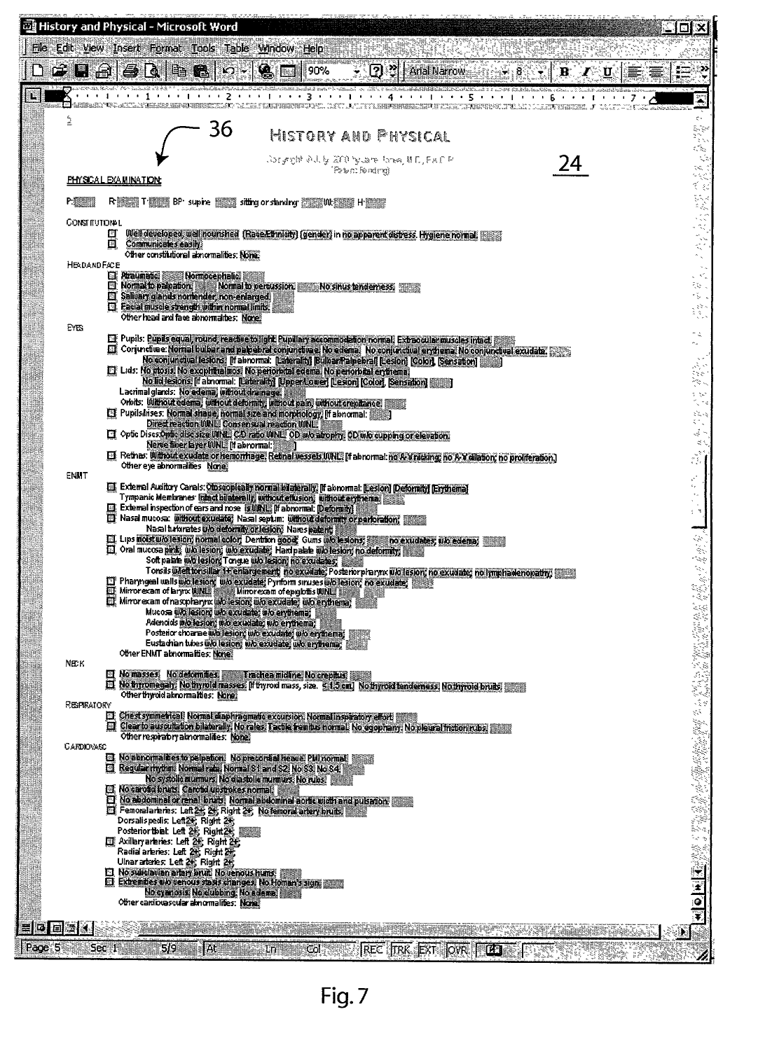

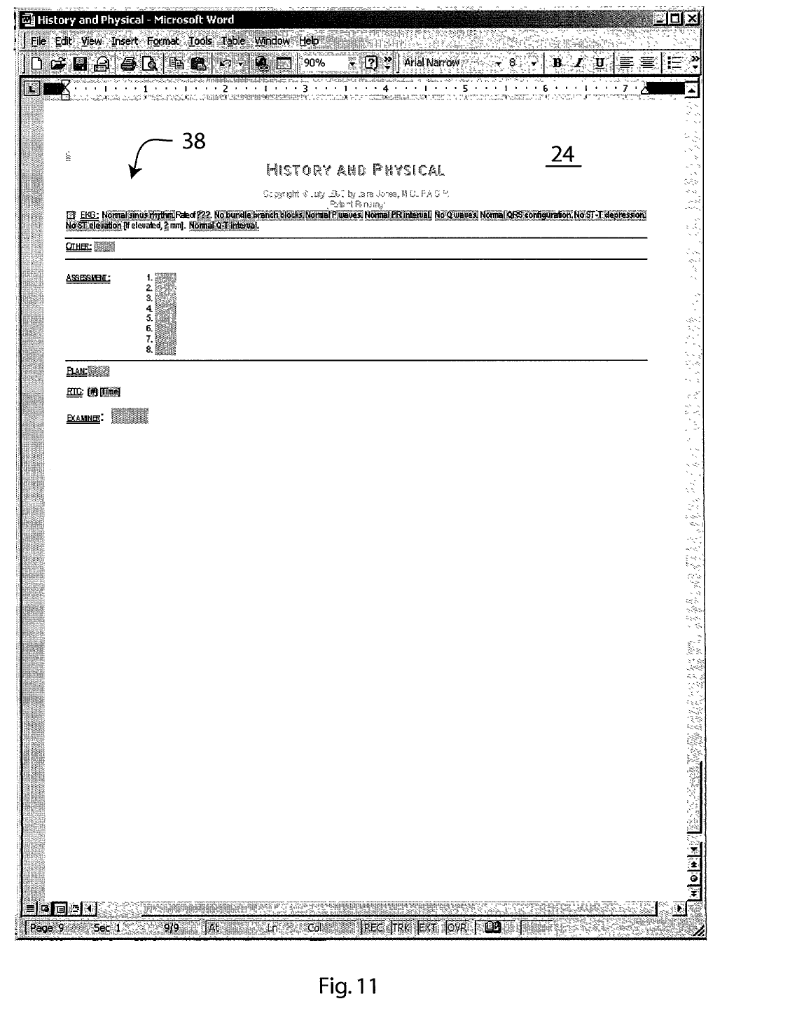

Referring to FIGS. 3-11, the computer program of the present invention preferably provides an input form 24 appearing on the display 12 as a series of screens or pages one through nine (corresponding to FIGS. 3-11, respectively). The input form 24 preferably includes multiple databases including medical information and each containing several tillable and selectable data fields corresponding to the relevant medical information. Once one or more of the data fields are filled, the input form 24 is preferably convertible into a printable output form. In more detail, the subprogram 16 preferably provides a background database 26 (see FIG. 3), a past medical history database 28 (see FIG. 3), a past surgical history database 30 (see FIG. 4), a family and social history database 32 (see FIG. 4), a review of systems database 34 (see FIGS. 4-6), a physical examination database 36 (see FIGS. 7-10), and a diagnosis database 38 (see FIG. 11). As shown in FIG. 3, the background database 26 preferably provides fillable and selectable data fields identifying background patient data to be collected such as name, birth date, and history of present illness.

As shown in FIGS. 3 and 4, the past medical history database 28 preferably provides tillable and selectable data fields identifying the patient's past medical history including relevant histories of disease (e.g., diabetes, etc.) and relevant prior medical procedures (e.g., last echocardiogram, etc.).

As shown in FIG. 4, the past surgical history database 30 preferably provides fillable and selectable data fields identifying the patient's past surgical history including relevant prior surgeries (e.g., hernia repair, etc.). Also as shown in FIG. 4, the family and social history database 32 preferably includes fillable and selectable data fields identifying the patient's family and social history including relevant histories of diseases present in the family (e.g., heart disease, etc.) or exposures experienced by the patient (e.g., tobacco use, etc.). Also included in the database 32 are fillable data fields relating to the patient's current medications, allergies, etc.

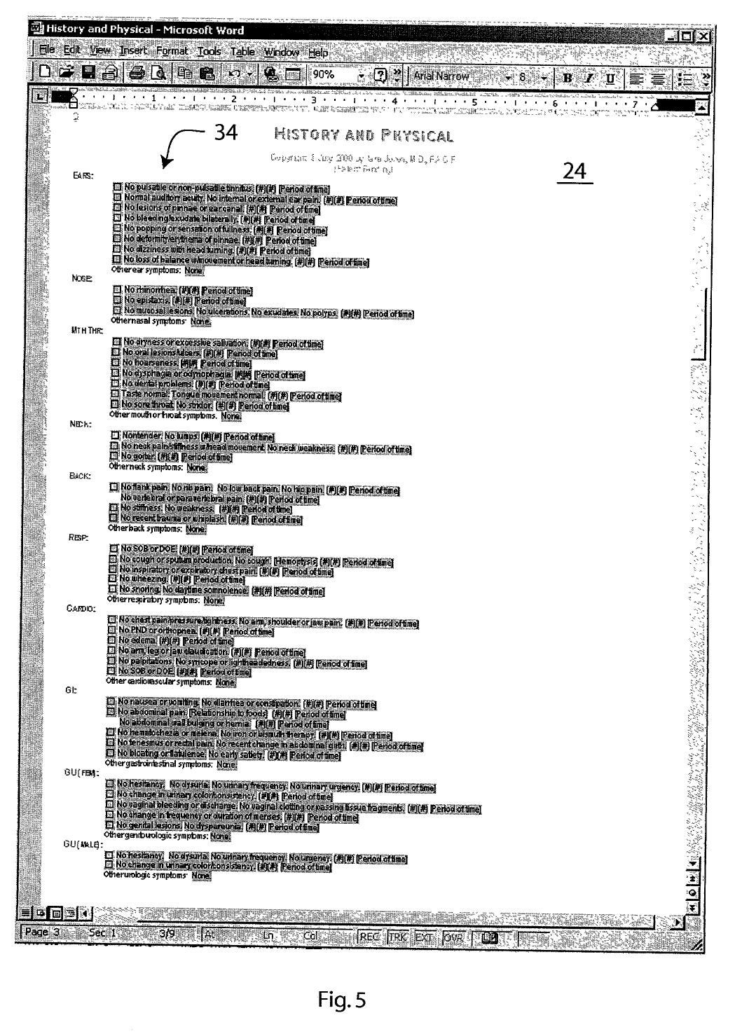

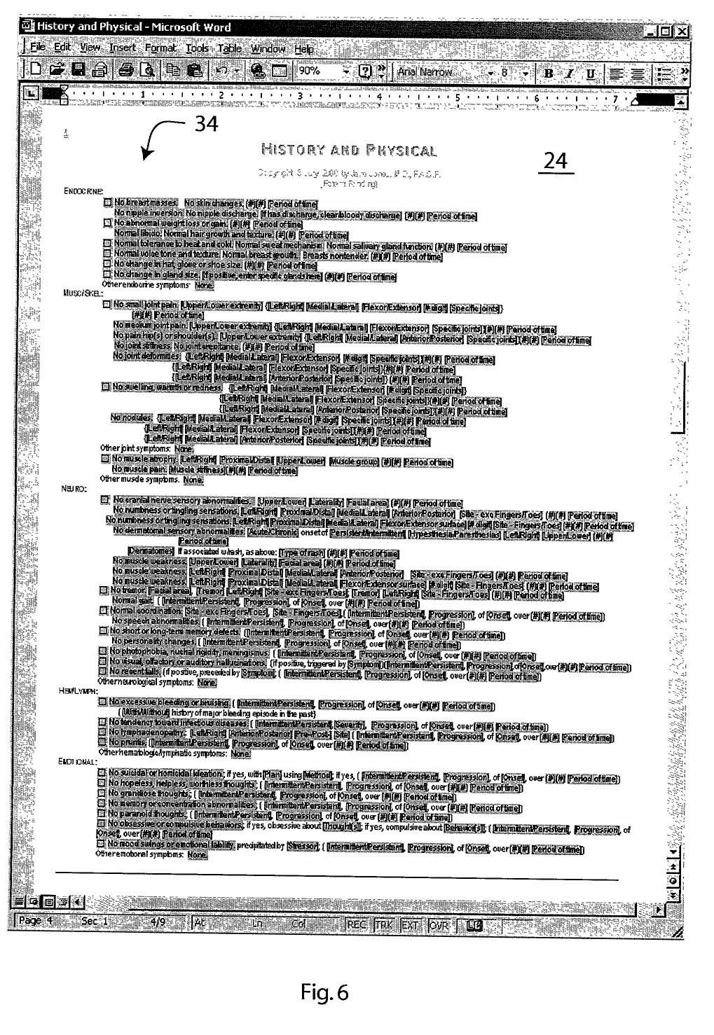

As shown in FIGS. 4-6, the review of systems database 34 preferably includes fillable and selectable data fields relating to the systems of the human body categorized for purposes of diagnosis and treatment by specific groupings. The data fields in the database 34 preferably include medical information relating to substantially all of the systems of the human body. In the illustrated database 34, all of the systems of the human body are incorporated into the following specific groupings: constitution, skin, head, eye (see FIG. 4), ears, nose, mouth and throat, neck, back, respiratory, cardiovascular, gastrointestinal, genitourologic (female), urologic (male) (see FIG. 5), endocrine, muscle and skeleton, neurological, hematologic and lymphatic, and emotional (see FIG. 6). Each specific grouping preferably includes medical information relevant to the systems of the grouping. In the illustrated input form 24, the medical information includes symptoms relevant to each system of the corresponding grouping. For example, the constitution grouping may include symptoms of weight fluctuation, fever, fatigue, insomnia, arthralgias, etc (see FIG. 4).

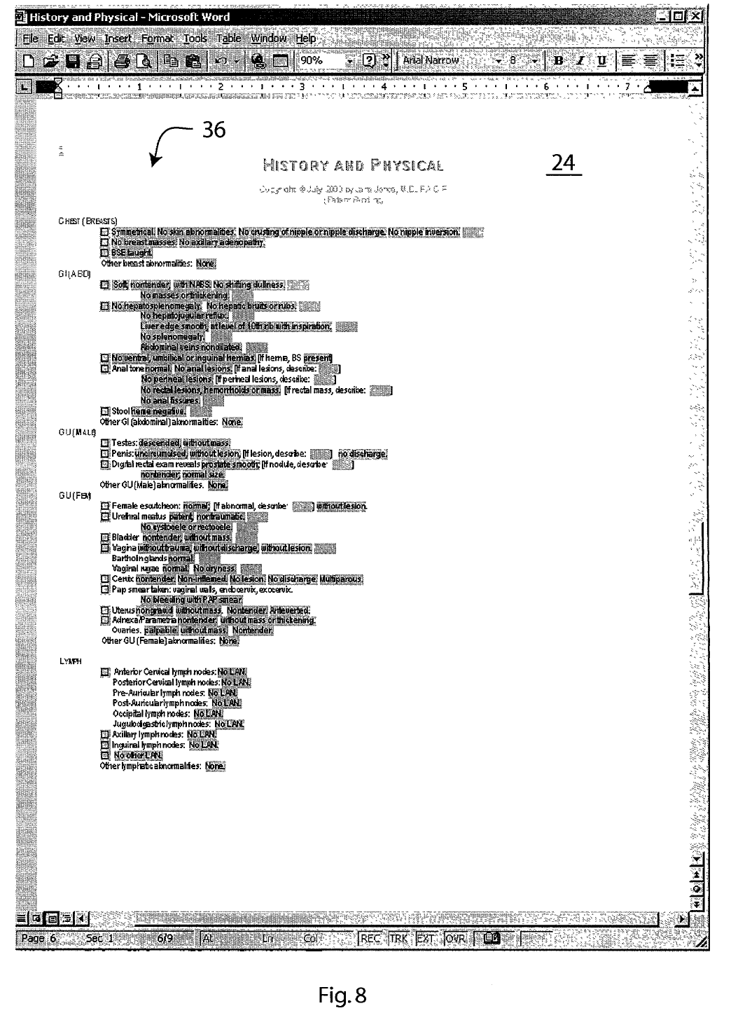

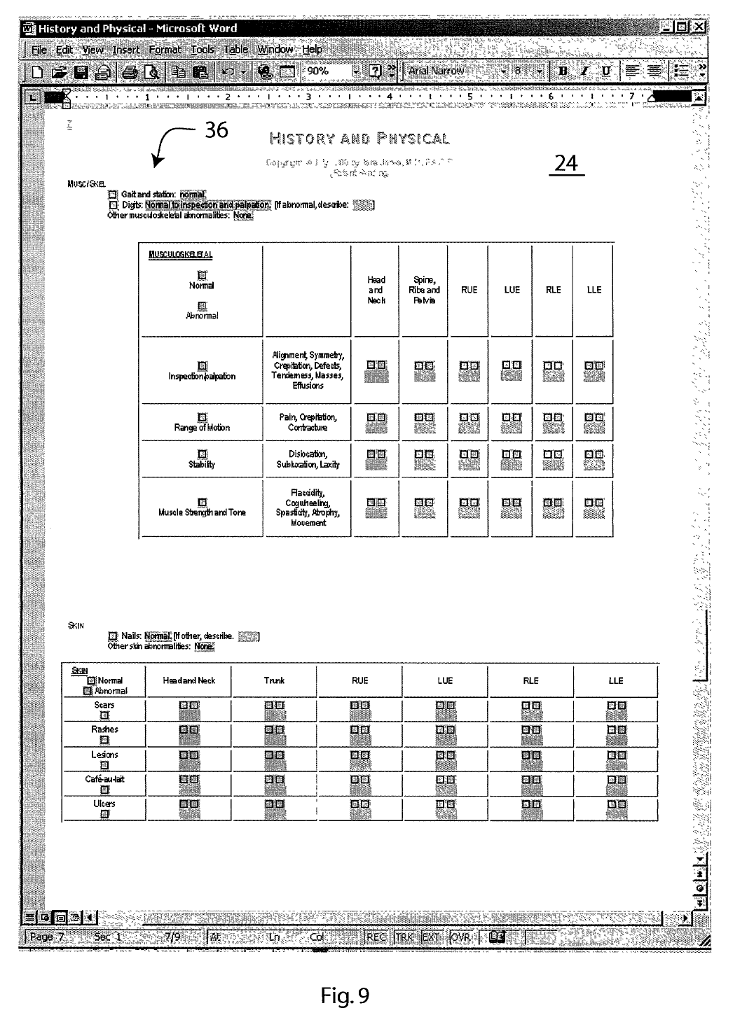

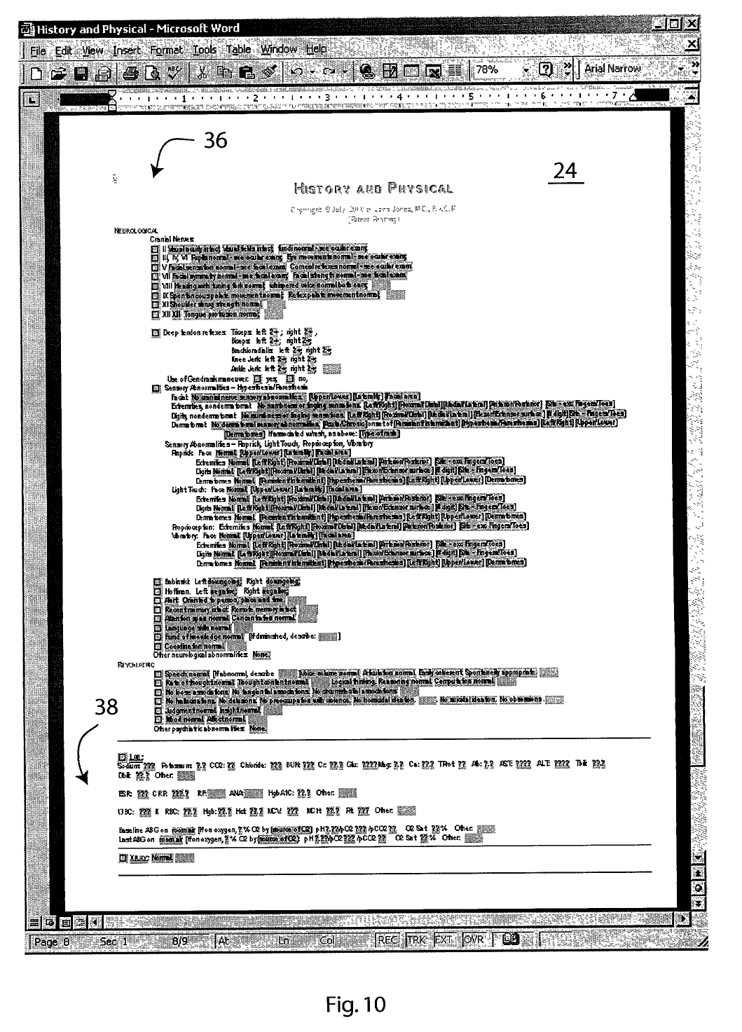

As shown in FIGS. 7-10, the physical examination database 36, like the previously discussed review of systems database 34, preferably includes fillable and selectable data fields relating to the systems of the human body. The systems of the body, however, are grouped somewhat different in the physical examination database 36. This grouping configuration is directed towards examination of the patient by the health care provider and includes data fields relating to medical findings in each grouping. It is believed these medical findings correspond with the findings necessary to comply with substantially all third party insurer's billing requirements. In the illustrated database 36, all of the systems of the human body are incorporated into the following specific groupings: constitutional, head and face, eyes, cars nose mouth and throat, neck, respiratory, cardiovascular (see FIG. 7), chest, gastrointestinal, genitourologic (female), urologic (male), lymph (see FIG. 8), muscle and skeleton, skin (see FIG. 9), neurological, and emotional (see FIG. 10). Each specific grouping preferably includes medical information relevant to the proscribed medical findings of the grouping. For example, in the illustrated input form 24, the constitutional grouping may include required medical findings relating to development, nourishment, race/ethnicity, gender, distress, hygiene, communication, etc (see FIG. 7).

As shown in FIGS. 10 and 11, the diagnosis database 38 preferably includes fillable and selectable data fields relating to the health care provider's diagnosis of the patient based on the previously conducted history and physical examination. The database 38 preferably includes diagnostic fields such as assessment, plan, and referral information (see FIG. 11). The database 38 could also include additional diagnostic testing information such as lab, X-ray, EKG, etc. (see FIG. 10).

As previously indicated, the second subprogram 18 is operable to receive patient data, the third subprogram 20 is operable to correlate the patient data with the medical information, and the fourth subprogram 22 is operable to generate a formatted report matching the patient data with the correlated medical information. In the illustrated input form 24, this is accomplished by the previously discussed fillable and selectable data fields. In more detail, patient data is received and stored in the data fields and each data field is correlated with the associated medical information. Once the data fields have been filled, the convertible input form 24 can be downloaded as the output form (e.g., a printable report, etc.). In the preferred computer program of the present invention, the data fields are in the form of drop down menus. The health care provider preferably enters the relevant patient data by selecting the corresponding drop down menu on the display 12 using the input device 14. This is preferably done at or near the time the data is obtained during the physical examination of the patient.

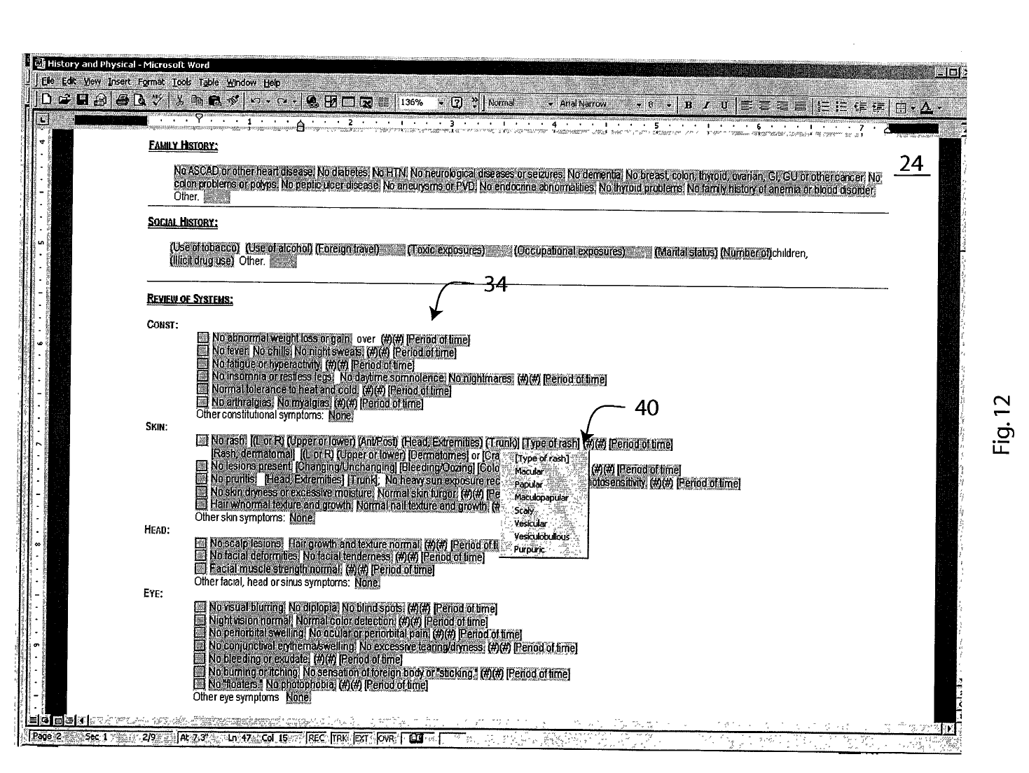

Referring to FIG. 12, by way of example, a screen capture generated by the computer program is shown including a drop down menu 40. The menu 40 is in the grouping for skin within the review of symptoms database 34. It will be appreciated that while the medical information associated with each data field differs, each drop down menu functions in a manner similar to menu 40 and accordingly only menu 40 will be described in detail. Medical information in the database 34 includes the symptom of rash under the specific grouping of skin. The rash symptom includes a series of drop down menus including menus relating to the following topics: no rash, left or right, upper or lower, anterior or posterior, head and/or extremities, trunk, type of rash, period of time, dermatomes, cranial nerves, etc (see FIG. 12). The drop down menu 40 corresponds to the type of rash. When the health care provider user touches the input device 14 to “type of rash” appearing on the display 12, the menu 40 drops down and appears as shown in FIG. 12. The menu 40 includes the various types of rashes including macular, papular, maculopapular, scaly, vesicular, vesiculobullous, and purpuric. The health care provider user simply touches the input device 14 on the relevant type of rash appearing in menu 40 on the display 12 and “type of rash” is replaced with the specific selection. In this manner, the health care provider user can quickly and easily input patient data without having to manually type or dictate it.

Moreover, because relevant symptoms are included for substantially all of the systems of the human body, with each having an associated drop down menu, the health care provider user is guided through, and/or is reminded of, relevant medical findings necessary for etiological purposes, as well as for a complete history and physical of the patient. Once the health care provider has filled the selected associated menu corresponding to the appropriate symptom, and an indicator mark (e.g., an X, a check, etc.) appears in the box next to the menu to indicate the presence (or absence) of the symptom. For example, as shown in FIG. 12, a box 42 is located to the far left of the “rash” symptom. In the example given above, once the health care provider user uses the input device 14 to select the type of rash in menu 40, a check mark appears in the box 42.

Once the health care provider has completed the history and physical (i.e., the input form 24 is completed), the input form 24 becomes the output form and various types of output can be generated therefrom (e.g., a printed report, a downloaded report, an electronically transmitted report, etc.). In this manner, the history and physical of the patient is complete and accurate and thereby facilitates the related billing (e.g., because substantially all of the relevant symptoms have been addressed, the history and physical will be compliant with most third party billing requirements).

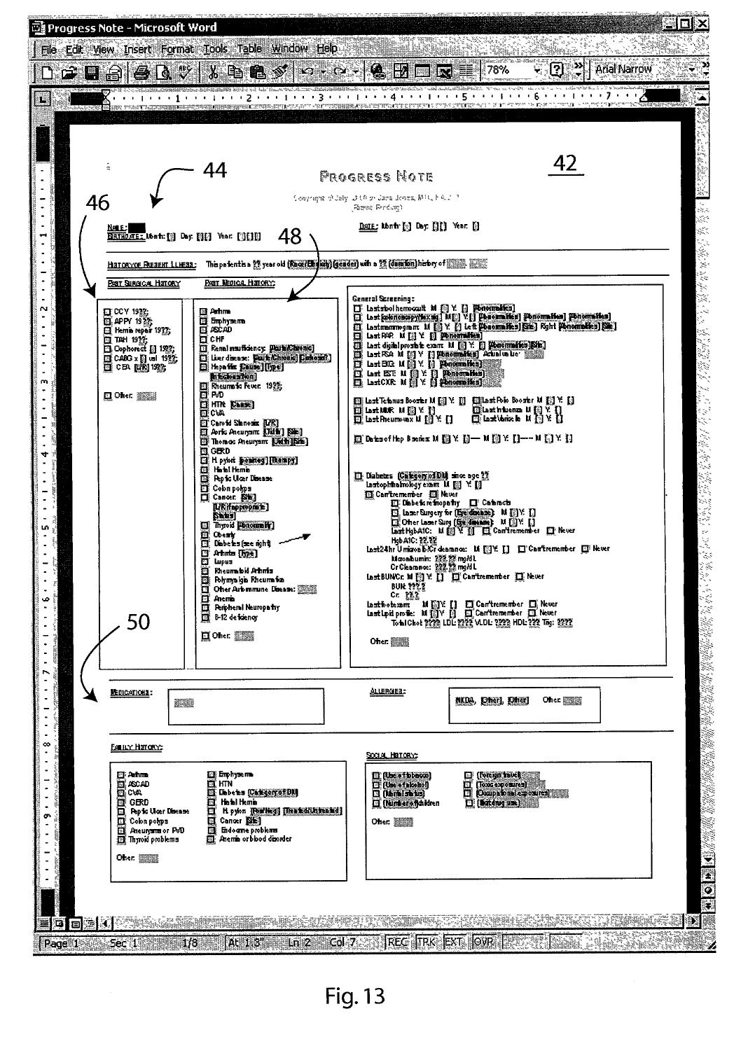

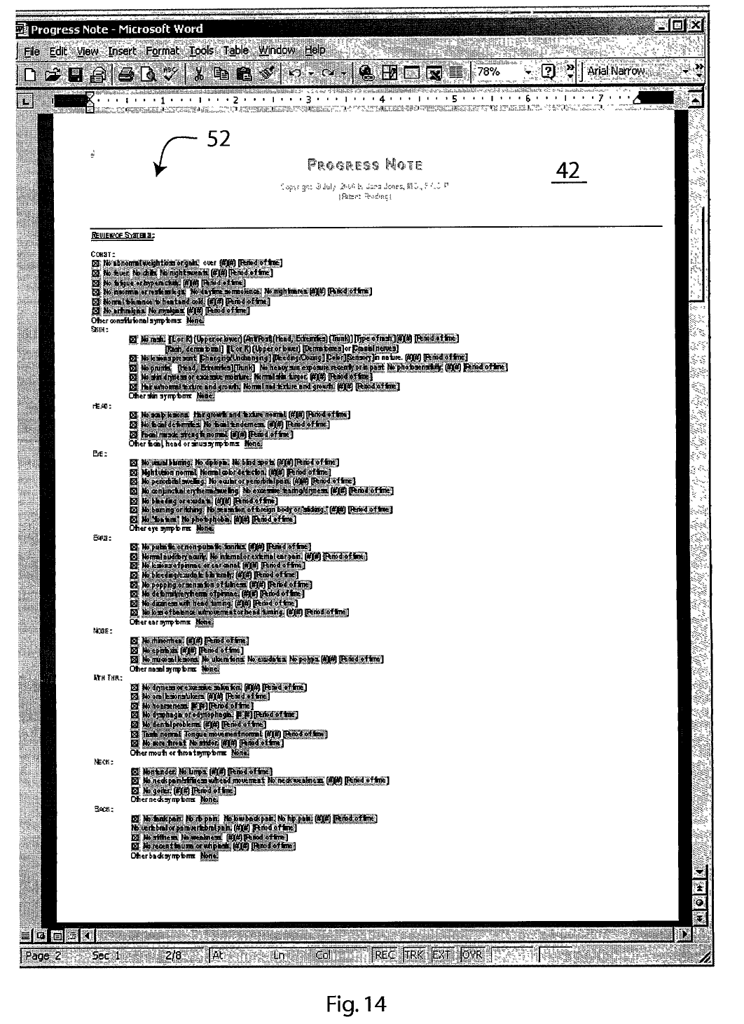

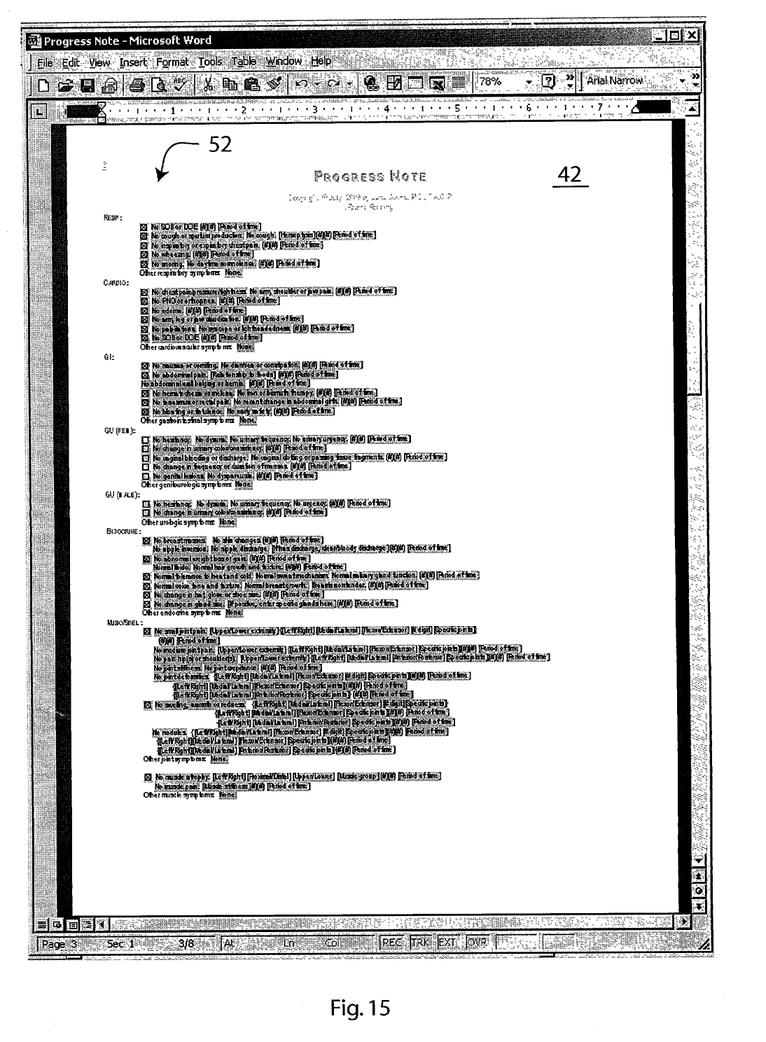

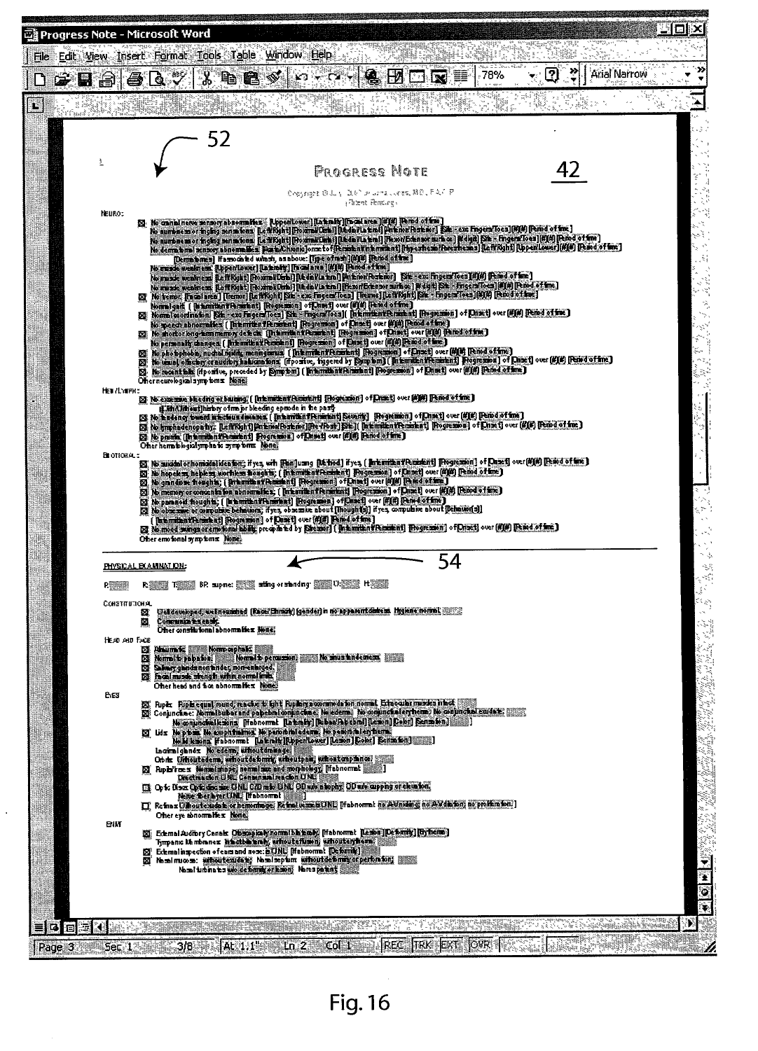

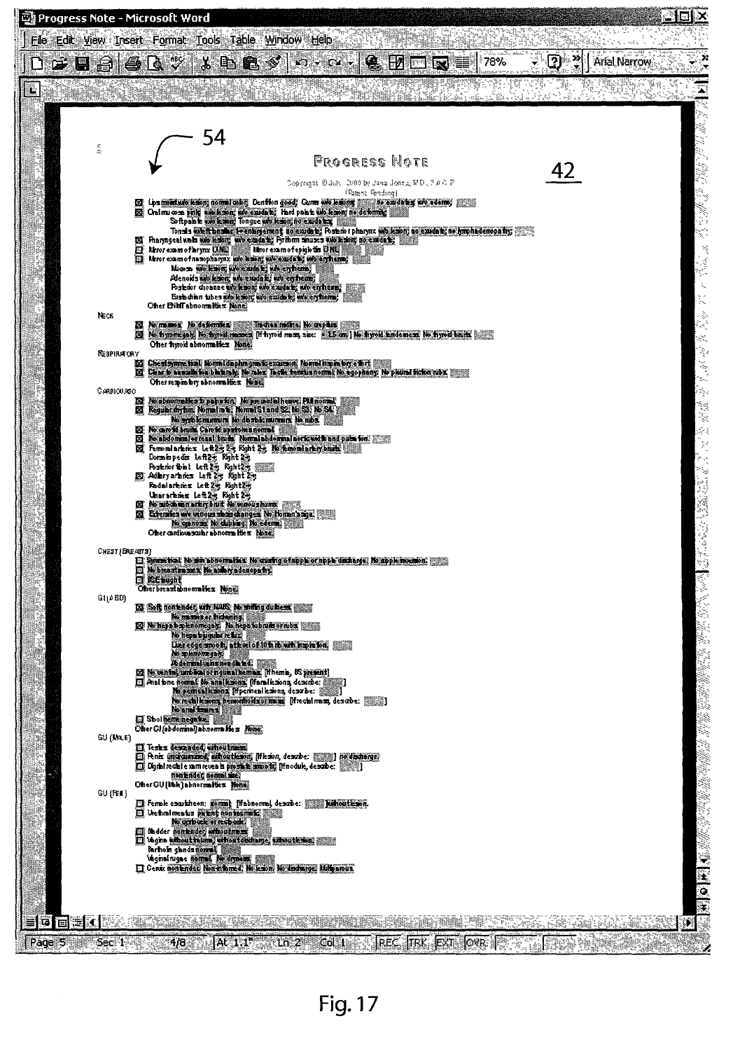

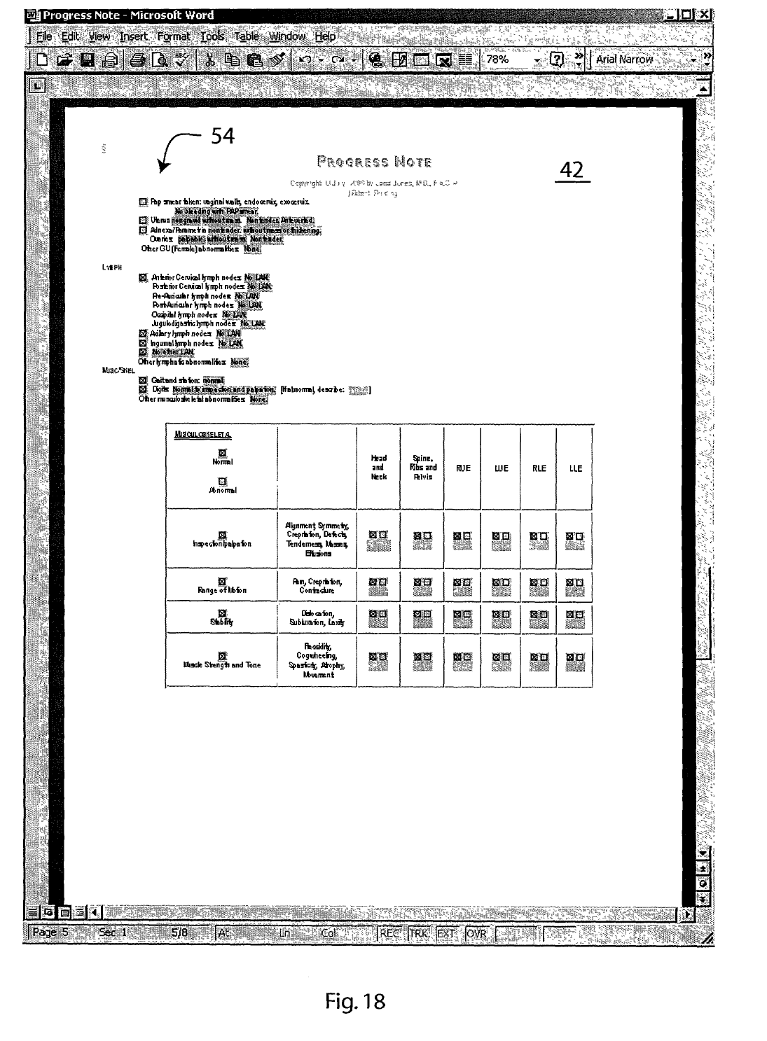

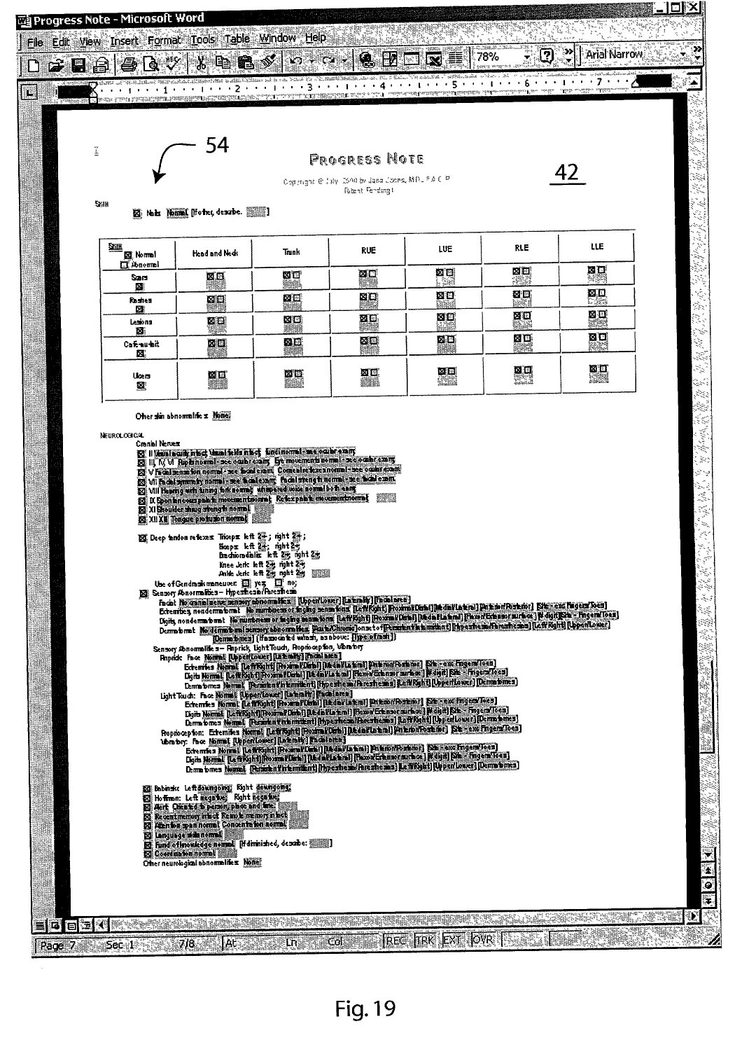

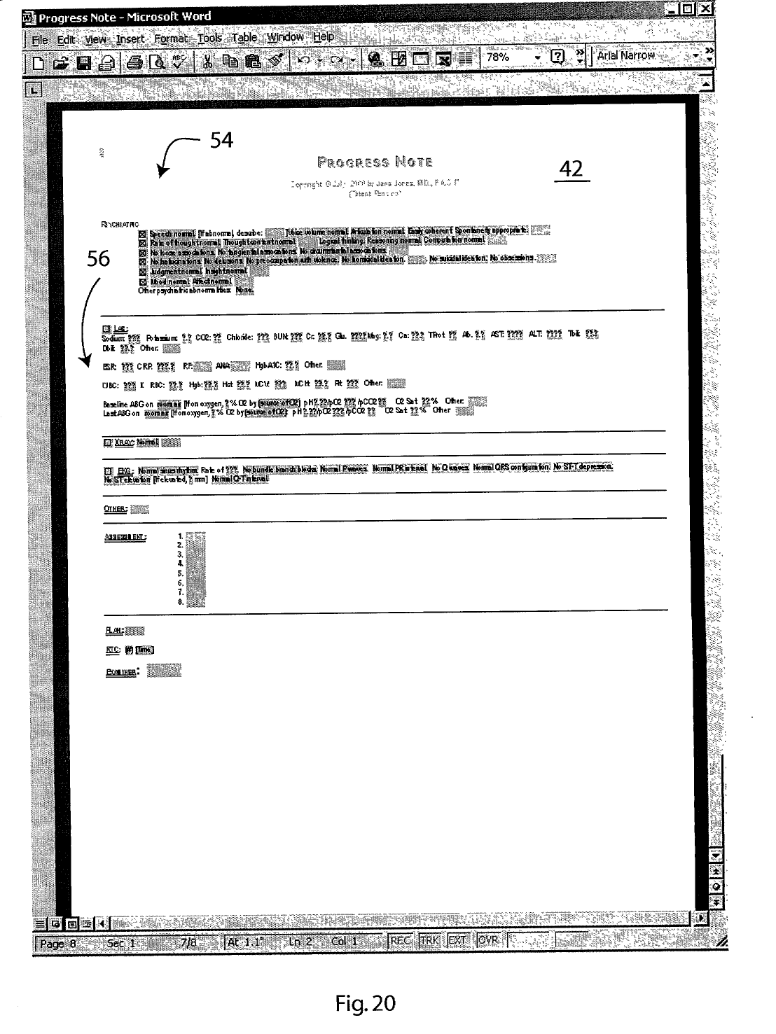

The principles of the present invention are equally applicable to various alternative configurations of the computer program so long as the program includes the medical information relevant to substantially all of the systems of the human body. Referring to FIGS. 13-20, one such alternative configuration is a computer program that generates the input form 42 appearing on a display as a series of screens or pages one through eight (corresponding to FIGS. 13-20, respectively). The computer program that generates the input form 42 is similar in the required hardware and operation as the previously discussed computer program that generated the previously discussed input form 24 and therefore will not be described in detail. The input form 42, however, is configured for a history and physical targeting progress notes for an existing patient rather than an initial history and physical of a new patient. The input form 42 is formatted slightly different than the previously discussed input form 24 to be more streamlined in respect to information that does not change (e.g., certain historical facts, etc.). Similar to the input form 24, the input form 42 includes a series of databases. The input form 42 includes a background database 44, a past surgical history database 46, a past medical history database 48, a family and social history database 50 (see FIG. 13), a review of symptoms database 52 (see FIGS. 14-16), a physical examination database 54 (see FIGS. 16-20), and a diagnosis database 56 (see FIG. 20). Similar to the input form 24, the series of databases 44,46,48,50,52,54,56 each including fillable and selectable data fields having associated medical information relating to the corresponding symptom, test, etc.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states her intent to rely on the Doctrine of Equivalents to determine and assess the reasonably fair scope of the present invention as pertains to any apparatus not materially departing from but outside the literal scope of the invention.

What is claimed is:

1. A method for facilitating medical treatment and related billing relating to one or more specific groupings of systems of the human body wherein the one or more groupings is selected from the group comprising substantially all of the specific groupings of systems of the human body, the method comprising the steps of:
(a) providing a data base including medical information for substantially all of the specific groupings of systems of the human body;
(b) providing an input mechanism operable to accept patient data;
(c) correlating the patient data with medical information from one or more of the specific groupings of systems of the human body; and
(d) generating a report matching the patient data with the correlated medical information.

2. The method as claimed in claim 1,
step (a) including the steps of including a plurality of first data tables in the database and filling each first data table with medical information for a respective one of the specific groupings of systems of the human body.

3. The method as claimed in claim 2,
step (a) further including the steps of including a plurality of second data tables operable to receive and store data in the database and associating each second data table with a respective one of the plurality of first data tables.

4. The method as claimed in claim 3,
step (c) including the step of matching any data received in one of the second data tables with medical information in the associated first data table.

5. The method as claimed in claim 4,
step (b) including the steps of providing an input form for display on a screen, dynamically linking the form to the plurality of first and second data tables, and enabling the form to interactively accept data for storage in the second data tables and retrieve data from the second data tables and medical information from the first data tables for editable presentation.

6. The method as claimed in claim 5,
step (d) including the steps of linking the report to the input form, dynamically linking the report to the first and second data tables, and enabling the report to retrieve data from the second data tables and medical information from the first data tables for formatable and printable presentation.

7. The method as claimed in claim 1,
step (a) including the step of including medical information in the data base for specific groupings of systems of the human body including constitution, skin, head, eye, ears, nose, mouth and throat, neck, back, respiratory, cardiovascular, gastrointestinal, genitourologic, urologic, endocrine, muscle and skeleton, neurological, hematologic and lymphatic, and emotional groupings.

8. A computer program for facilitating medical treatment and related billing relating to one or more specific groupings of systems of the human body wherein the one or more groupings is selected from the group comprising substantially all of the specific groupings of systems of the human body, the computer program being stored on a computer-readable medium and executable by a computing device, the program comprising:
a first code segment operable to provide a data base including medical information for substantially all of the specific groupings of systems of the human body;
a second code segment operable to provide an input mechanism operable to accept patient data;
a third code segment operable to correlate the patient data with medical information from one or more of the specific groupings of systems of the human body; and
a fourth code segment operable to generate a report matching the patient data with the correlated medical information.

9. The program as claimed in claim 8,
said first code segment including code operable to include a plurality of first data tables in the database and fill each first data table with medical information for a respective one of the specific groupings of systems of the human body.

10. The program as claimed in claim 9,
said first code segment further including code operable to include a plurality of second data tables operable to receive and store data in the database and associate each second data table with a respective one of the plurality of first data tables.

11. The program as claimed in claim 10,
said third code segment including code operable to match any data received in one of the second data tables with medical information in the associated first data table.

12. The program as claimed in claim 11,
said second code segment including code operable to provide an input form for display on a screen, dynamically link the form to the plurality of first and second data tables, and enable the form to interactively accept data for storage in the second data tables and retrieve data from the second data tables and medical information from the first data tables for editable presentation.

13. The program as claimed in claim 12,
said fourth code segment including code operable to link the report to the input form, dynamically link the report to the first and second data tables, and enable the report to retrieve data from the second data tables and medical information from the first data tables for formatable and printable presentation.

14. The program as claimed in claim 8,
said specific groupings of systems of the human body including constitution, skin, head, eye, ears, nose, mouth and throat, neck, back, respiratory, cardiovascular, gastrointestinal, genitourologic, urologic, endocrine, muscle and skeleton, neurological, hematologic and lymphatic, and emotional groupings.

15. A system for facilitating medical treatment of a patient and related billing relating to specific groupings of systems of the human body, the system comprising:
a handheld computing device including a memory, a display, an input mechanism, and an output mechanism; and
a computer program stored in the memory and executable to process medical information relating to substantially all of the specific groupings of systems of the human body,
said computer program including a first code segment providing a database stored in the memory and including medical information for substantially all of the specific groupings of systems of the human body when the first code segment is executed,
said computer program including a second code segment controlling the input mechanism to accept patient data when the second code segment is executed,
said computer program including a third code segment correlating the patient data with medical information from one or more of the specific groupings of systems of the human body when the third code segment is executed,
said computer program including a fourth code segment generating a report matching the patient data with the correlated medical information when the fourth code segment is executed.

16. The system as claimed in claim 15,
said first code segment including code providing a plurality of first data tables in the database and filling each first data table with medical information for a respective one of the specific groupings of systems of the human body when the first code segment is executed.

17. The system as claimed in claim 16,
said first code segment further including code providing a plurality of second data tables to receive and store data in the database and associating each second data table with a respective one of the plurality of first data tables when the first code segment is executed.

18. The system as claimed in claim 17,
said third code segment including code matching any data received in one of the second data tables with medical information in the associated first data table when the third code segment is executed.

19. The system as claimed in claim 18,
said second code segment including code providing an input form to the display, dynamically linking the form to the plurality of first and second data tables, and enabling the form to interactively accept data for storage in the second data tables and retrieve data from the second data tables and medical information from the first data tables for editable presentation when the second code segment is executed.

20. The system as claimed in claim 19,
said fourth code segment including code linking the report to the input form, dynamically linking the report to the first and second data tables, and enabling the report to retrieve data from the second data tables and medical information from the first data tables for formatable and downloadable presentation to the output mechanism when the fourth code segment is executed.

21. The system as claimed in claim 15,
said specific groupings of systems of the human body including constitution, skin, head, eye, ears, nose, mouth and throat, neck, back, respiratory, cardiovascular, gastrointestinal, genitourologic, urologic, endocrine, muscle and skeleton, neurological, hematologic and lymphatic, and emotional groupings.

22. The system as claimed in claim 15,
said input mechanism including a stylus.

23. The system as claimed in claim 15,
said output mechanism including a modem.
